(19) United States
(12) Patent Application Publication
(10) Pub. No.: US 2018/0057899 A1
(43) Pub. Date: Mar. 1, 2018

(54) METHOD FOR CUTTING NATURAL HIDES AND THE LIKE

(71) Applicant: COMELZ S.P.A., Vigevano (IT)

(72) Inventor: Alessandro CORSICO PICCOLINO, Vigevano (IT)

(73) Assignee: COMELZ S.P.A., Vigevano (IT)

(21) Appl. No.: 15/551,436

(22) PCT Filed: Feb. 18, 2016
(86) PCT No.: PCT/EP2016/053469

§ 371 Date: Aug. 16, 2017

(30) Foreign Application Priority Data
Feb. 20, 2015 (IT) MI2015A000252

(51) Int. Cl. C14B 5/00; C14B 17/04; C14B 17/06; B26F 1/38; B26D 7/00; B26D 5/00

(52) U.S. Cl. CPC C14B 5/00; C14B 17/04; B26D 5/00; B26F 1/3813; B26D 7/00; C14B 17/06

(57) ABSTRACT

A method for cutting natural hides, on cutting machines comprising a conveyor belt on which a hide to be cut is arranged, and at least one longitudinal cantilever arm for supporting a cutting head, comprising the steps of:
on a conveyor belt of the machine that is divided into a placement area, a cutting area and a collection area, wherein the collection area is an area of the conveyor belt toward which the at least one supporting arm protrudes with the corresponding cutting head, placing a hide on the placement area;
defining a cutting layout on the hide;
advancing the hide at the cutting area;
by means of a collection operator, located at the collection area and directed toward the supporting arm with corresponding cutting head, rearranging the hide when it is at the cutting area;
advancing the hide toward the collection area and collecting the cut pieces.

The present invention relates to a method for cutting natural hides and the like.

More particularly, the invention relates to a method for cutting natural hides and the like that allows to achieve an improved work efficiency with respect to conventional methods.

As is known, in cutting natural hides with numeric control systems the perfect spreading of the hide on the suction cutting plane on which the cutting head is working is fundamentally important.

In view of their original curved shape, derived from the animal from which they originate, the hides, even after the processes for tanning and preparation for cutting, usually have internal tensions that contrast perfect spreading on a flat surface used as a support for numeric control cutting by means of cutting tools that can move along such surface. Furthermore, due to the storage methods used, the hides often have folded edges that resist being spread on a surface.

The method currently used to make the hides adhere to the cutting plane is to provide such plane with vacuum generation systems, which, by means of a breathable resting surface, create a partial vacuum on the lower zo surface of the hide that pushes it into contact with such plane, avoiding first of all its displacement under the effect of the cutting tools along the cutting path.

In practice, however, upon actuation of the vacuum generation means the hide is pushed against the aspirated surface unevenly, generating wrinkles of such hide that do not allow its correct cutting.

Moreover, the simple actuation of the vacuum generation means does not ensure the “unfolding” of any folded lateral edges. Even the presser plates that surround the cutting tools are unable to achieve this task once the hide has been locked on the surface by suction.

Some technical implementations provide, in the case of thicker and more rigid materials, for the use of presser rollers that act along the entire width of the cutting table, but these are instruments that however solve a limited range of cases.

Substantially, therefore, usually, in order to ensure perfect spreading of the hide on the suction cutting plane, one must necessarily resort to the manual intervention of the operator, who is able, after the activation of the vacuum generation means, to flatten the wrinkles, taking advantage also of the possibility to lift the external flap of the hide, thus performing merely manual operations that require good accessibility of the area involved and which in practice cannot be mediated by tools or extensions to be used from a distance.

Therefore, in ideal conditions, the cutting system must allow the operator to intervene directly, on every portion of hide to be cut, after the activation of the suction and before the start of the cutting operations.

It should be noted that cutting systems provided with conveyor belts also must comply with this requirement, since it is not possible to perform the spreading and cutting operation on two different stations even if they are connected by the conveyor belt, due to the fact that the motion of the conveyor belt requires the elimination (or at least reduction) of the partial vacuum of the suction plane in order to eliminate the friction between the belt and the plane generated by the partial vacuum and allow the sliding of such conveyor belt on the surface of the underlying suction plane during movement and therefore, by releasing suction in order to perform a movement of the conveyor belt, the hide would lose adhesion to the plane and would then have to be rearranged again once it has reached the cutting position.

Currently, conveyor belt systems with a structure for the movement of the heads on longitudinal arms (i.e., extended along the direction of motion of the conveyor belt) substantially provide for three operating areas that are extended in a cascade arrangement along the movement of the conveyor belt in one direction, i.e.:
placement area, where the placement operator places the hide to be processed and establishes its part cutting layout (manually, by interaction with the control computer, or automatically, giving the control the task of calculating and/or arranging on the hide the cutting layout with appropriate input and vision instruments);
area for cutting, performed by tool heads, which are usually a plurality, moved by the corresponding movement axles by means of an architecture with minimal space occupation impact, i.e., which leaves the area around each tool head clear from the space occupations constituted by its own movement supports, such as for example horizontal or vertical cantilever supporting arms (where a vertical cantilever is understood as a structure in which the longitudinal arm also cantilevers out horizontally with respect to its own supporting beam, but moreover is in a raised position with respect to the working surface, allowing the downward hanging of an additional arm that supports the tool head at the height of the working surface), with the goal of improving further accessibility and visibility around the head;
collection area, where a collection operator collects the cut pieces.

In these solutions, to a more or less conspicuous extent, there is an overlap between the placement and cutting areas that allows the operator to reach (more or less completely, depending on the circumstances) the portion of hide that is present in the cutting area from the placement area. In practice this allows the portion of hide to be cut, once it has been conveyed by the conveyor belt onto the cutting area and once suction has been subsequently reactivated, it can be handled and arranged by the operator before proceeding with cutting, without additional further intermediate displacements of the belt.

Moreover, more importantly, the placement operator, from the placement area, monitors the execution of the cutting operations and if necessary intervenes manually on said area to correct any problems, being able to access the cutting area over the entire depth that he can reach on the surface, including the spaces that surround the tool heads, this being achieved also by using the safety systems that interrupt the cutting operations when the cutting area is invaded.

In these architectures, but only in the case of the cutting of synthetic materials in plates or rolls, the direction of motion of the conveyor belt can be reversed, reserving the station from which the cutting area is accessible by the operator, in the manner described above, only to the collection operation, due to the fact that these types of material are provided to the cutting system automatically without the assistance of a permanent loading operator and at the same time do not require manual placement of the cutting layout, since they have a regular shape that is known in advance and can be calculated beforehand.

In any case, in this situation the operator does not need to intervene in the cutting area to rearrange the material, indeed because it is not natural material that has the typical spreading problems of hides, as described above.

There are also other systems (with or without a conveyor belt) that face the area that can be accessed by the operator (both placement operator and collection operator) with one or more transverse bridges provided with one or more tool heads that can slide laterally along such bridges or with a double transverse bridge that supports one or more longitudinal bridges that are enclosed and can slide between the two transverse bridges, each provided with a tool head that can slide laterally along them.

In these systems, the structures for moving the tool heads occupy the cutting area over its entire width, in practice hindering the possibility to monitor the correct execution of cutting and to access the area that surrounds the cutting heads.

The aim of the present invention is to provide a method for cutting hides and the like that allows to make the cutting operation more efficient.

Within this aim, an object of the present invention is to provide a method for cutting hides and the like that allows to optimize the operative capability of the operators assigned to hide placement and to cut pieces collection, by transferring from the placement operator (a fundamental resource on which the productivity of the system depends) to the collection operator (a non-specialized assistant) the task of rearranging the hide before and during cutting, with reference to the systems of the type with minimal space occupation impact described above.

Another object of the present invention is to provide a method for cutting hides that is highly reliable, relatively simple to provide and at competitive costs.

This aim, as well as these and other objects that will become better apparent hereinafter, are achieved by a method for cutting natural hides and the like, on cutting machines comprising a conveyor belt on which a hide to be cut is arranged, and at least one longitudinal cantilever arm for supporting a cutting head adapted to cut such hide, characterized in that it comprises the steps of:

on a conveyor belt of the machine that is divided into a placement zo area, a cutting area and a collection area, wherein the collection area is an area of the conveyor belt toward which said at least one supporting arm protrudes with the corresponding cutting head, placing, by means of a placement operator, a hide on said placement area;

defining a cutting layout on said hide;

advancing said hide at said cutting area in order to cut the hide by means of said at least one cutting head;

by means of a collection operator, located at said collection area and directed toward said at least one supporting arm with corresponding cutting head, rearranging said hide when it is at said cutting area;

advancing said hide toward the collection area and collecting the cut pieces.

Further characteristics and advantages of the invention will become better apparent from the description of a preferred but not exclusive embodiment of the method according to the present invention, illustrated by way of nonlimiting example in the accompanying drawings, wherein:

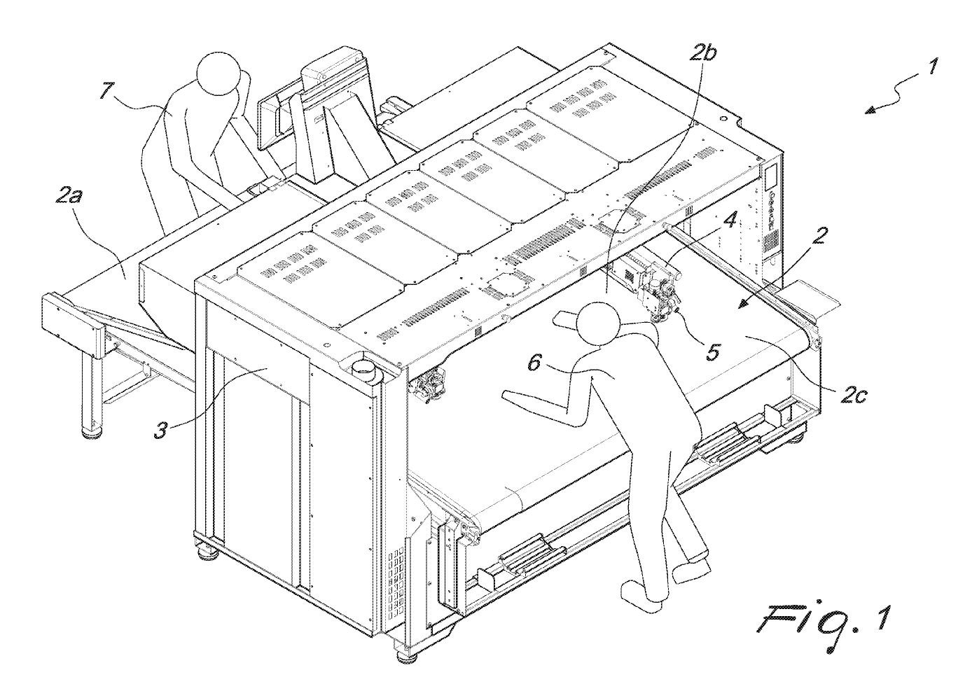

FIG. 1 is a perspective view of a hide cutting machine to which a method according to the invention is applied;

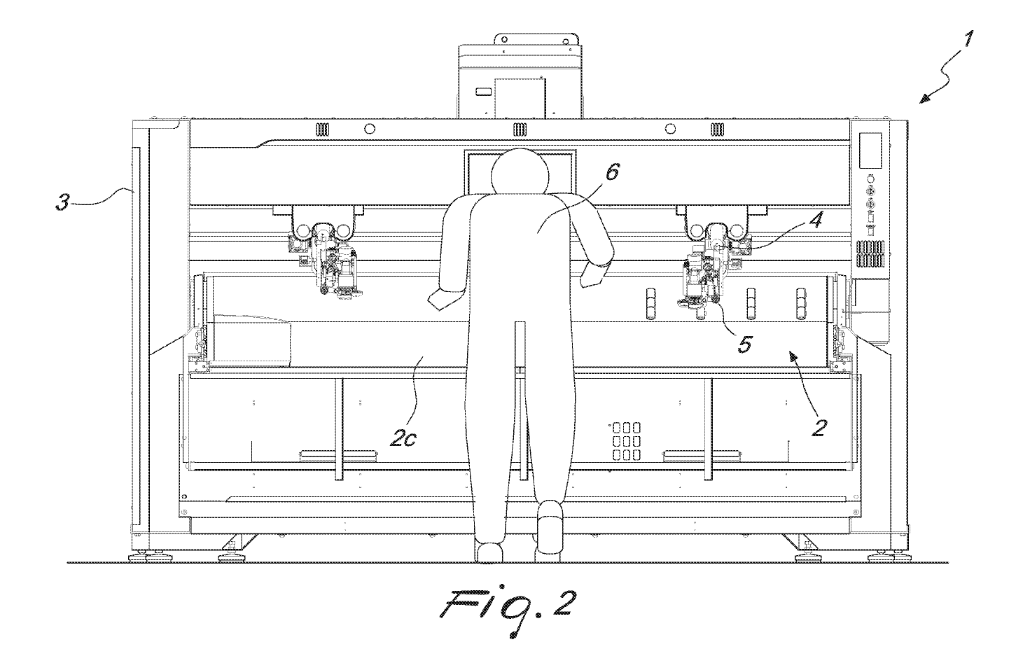

FIG. 2 is a front elevation view of the machine of FIG. 1;

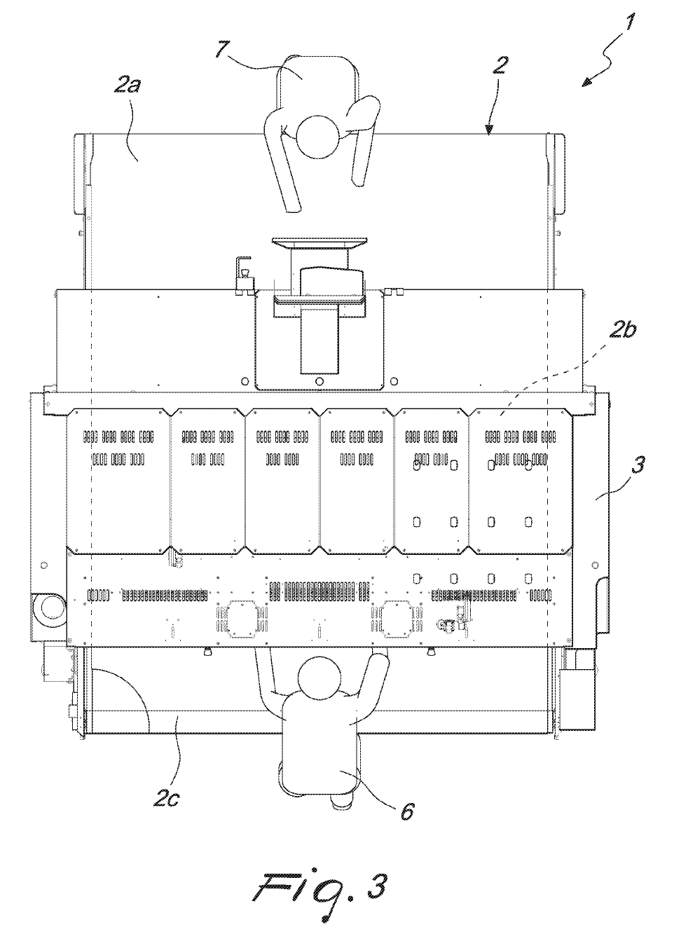

FIG. 3 is a top plan view of the machine of FIG. 1;

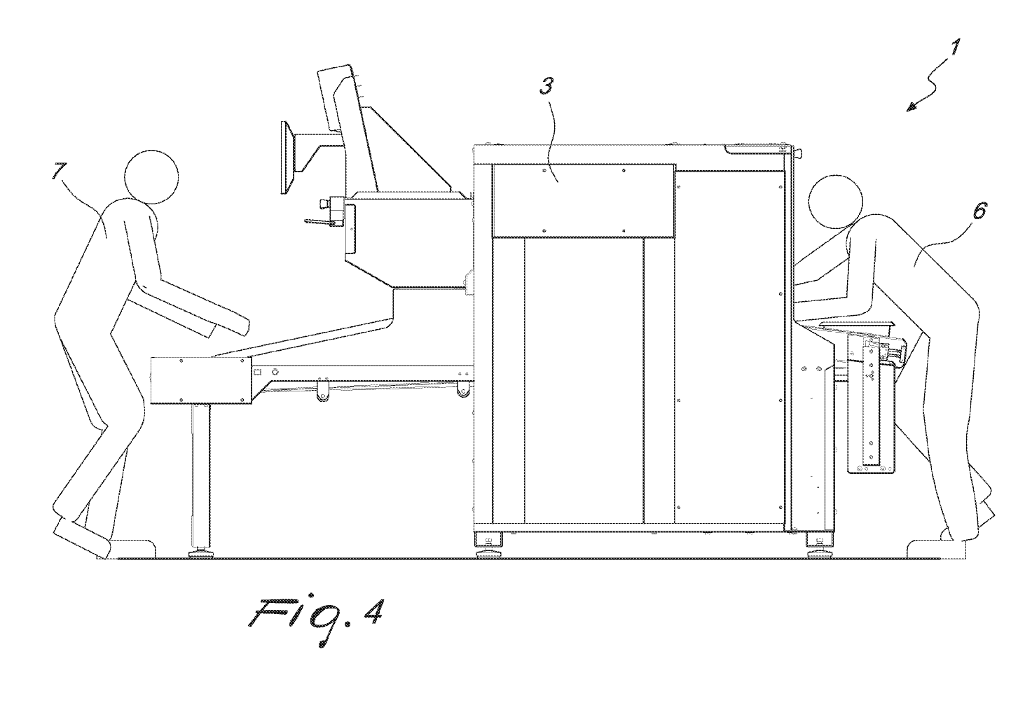

FIG. 4 is a side elevation view of the machine of FIGS. 1-3.

With reference to the figures, the machine, designated generally by the reference numeral 1, is a machine for cutting hides and the like, which comprises a conveyor belt 2, a framework 3 that is arranged so as to lie above the conveyor belt 2 and supports at least one longitudinal cantilever arm 4, for supporting a cutting head 5.

Conveniently, the machine can have two or more arms for supporting corresponding cutting heads.

The conveyor belt 2 can be divided conveniently into a placement region 2a, a cutting region 2b, below one or more cutting heads 5, and a collection region 2c.

An operator 7, with the task of placing the hide, is located at the placement area 2a of the conveyor belt and a collection operator 6 is located at the collection area 2c, but this last operator 6 can interact with the cutting area 2b.

Substantially, therefore, the placement operator 7 and the collection operator 6 are arranged in diametrically opposite positions with respect to the positions usually assumed by such operators in hide cutting machines of the type shown in FIGS. 1 to 4.

Likewise, the conveyor belt is divided into areas that are reversed with respect to the current use of such conveyor belt. In other words, the placement area 2a would usually be an area dedicated to the collection of the cut pieces, while the collection area 2c would be the area dedicated to placement.

Substantially, therefore, placement is identified on the conveyor belt 2 as the area that lies opposite the cutting heads, i.e., the area that lies opposite the area 2c toward which the cutting heads protrude.

The method according to the invention provides for the use of hide cutting machines that have minimal space occupations as regards the arms 4 and the corresponding cutting heads 5, so that the operator 6 can interact with the cutting area easily, though being located frontally with respect to the machine, at the cutting area 2c.

The method according to the invention therefore develops in a cascade arrangement along the conveyor belt 2 on the three areas 2a, 2b and 2c in the following manner.

In a first step, automatic loading of the hide on the area 2a of the conveyor belt 2 occurs and the cutting layout is prepared manually or automatically.

The hide is then made to advance at the area 2b of the conveyor belt 2, i.e., in the area of action of the cutting head or heads 5.

When the hide is in the cutting area, the collection operator 6 can interact with the hide, reach the cutting area and arrange, by flattening it, the hide on the plane of the conveyor belt 2, aided in this by adapted photocells which, when the operator invades the cutting area, inhibit the operation of the cutting heads 5.

When the hide passes, conveyed by the conveyor belt 2, into the cutting area 2b, it is subjected to suction, and the hide is then spread and rearranged manually by the operator 6, who accesses the cutting area from the collection area 2c in order to obtain perfect adhesion and spreading of the hide on the cutting plane.

The cutting head or heads 5 then proceeds or proceed with hide cutting, while the operator 6 can still intervene in the cutting area 2b to spread and rearrange the hide or even pick up already cut pieces (by using the safety systems described above, which temporarily interrupt the motion of the heads 5).

The hide then passes to the collection area 2c, where the operator 6 collects the cut pieces, while he can however continue to monitor the cutting area 2b, ready to intervene as in the preceding step.

Therefore, the work method according to the invention provides for a reversal of the roles of the collection operator 6 and placement operator 7 and for a reversal of the positions of such operators with respect to the conveyor belt 2 of the machine 1.

The work method described above allows to speed up the cutting operations and therefore to optimize the cutting work in general.

In practice it has been found that the cutting method according to the present invention achieves fully the intended aim and objects, since it allows to optimize processing on natural hides that require frequently to be rearranged by an operator after they have been placed on the placement area and while they are being cut.

The method thus conceived is susceptible of numerous modifications and variations, all of which are within the scope of the appended claims.

All the details may further be replaced with other technically equivalent elements.

The disclosures in Italian Patent Application No. MI2015A000252 (102015902332185) from which this application claims priority are incorporated herein by reference.

1-9. (canceled)

10. A method for cutting natural hides and the like, on cutting machines comprising a conveyor belt on which a hide to be cut is arranged, and at least one longitudinal cantilever arm for supporting a cutting head adapted to cut said hide, the method comprising the steps of:
on a conveyor belt of the machine that is divided into a placement area, a cutting area and a collection area, wherein the collection area is an area of the conveyor belt toward which said at least one supporting arm protrudes with the corresponding cutting head, placing, by means of a placement operator, a hide on said placement area;
defining a cutting layout on said hide;
advancing said hide at said cutting area in order to cut the hide by means of said at least one cutting head;
by means of a collection operator, located at said collection area and directed toward said at least one supporting arm with corresponding cutting head, rearranging said hide when it is at said cutting area;
advancing said hide toward the collection area and collecting the cut pieces.

11. The method according to claim 10, wherein the collection operator has the task of collecting the cut pieces at said collection area and of intervening at said cutting area in order to rearrange said hide.

12. The method according to claim 10, wherein the hide is subjected to aspiration at said cutting area.

13. The method according to claim 10, wherein at said cutting area said hide is spread manually by the collection operator, who accesses said cutting area from said collection area.

14. The method according to claim 10, wherein the intervention of the collection operator at said cutting area stops said at least one cutting head.

15. A machine for cutting natural hides and the like, comprising a conveyor belt that is adapted to convey a hide to be cut, said conveyor belt being divided into a placement area, a cutting area and a collection area, at least one cutting head, adapted to act on said cutting area, being supported by an arm that is extended in a cantilevered manner along the direction of motion of the conveyor belt, wherein said placement area is arranged in the opposite position, on said conveyor belt, with respect to the extension of said arm that supports said cutting head, said collection area being defined, on said conveyor belt, so as to lie opposite said placement area, and being an area of said conveyor belt toward which said arm that supports said cutting head is extended.

16. The machine for cutting natural hides and the like according to claim 15, wherein said area of the conveyor belt identified as the cutting area is provided with suction in order to spread the hide on said cutting area.

17. The machine according to claim 15, wherein a space occupation of said arm with said cutting head is such as to allow a collection operator located at said collection area to interact in said cutting area, in order to rearrange the hide when said hide is arranged at said cutting area.

18. The machine according to claim 15, further comprising at least two cutting heads.
